(19) United States
(12) Patent Application Publication
(10) Pub. No.: US 2016/0140954 A1
(43) Pub. Date: May 19, 2016

(54) SPEECH RECOGNITION SYSTEM AND SPEECH RECOGNITION METHOD

(71) Applicant: HYUNDAI MOTOR COMPANY, Seoul (KR)

(72) Inventor: Sung Soo PARK, Seoul (KR)

(21) Appl. No.: 14/936,125

(22) Filed: Nov. 9, 2015

(30) Foreign Application Priority Data
Nov. 14, 2014 (KR) 10-2014-0158774

(51) Int. Cl. G10L 15/02; G10L 15/22; G10L 15/06; G10L 15/20

(52) U.S. Cl. CPC G10L 15/02; G10L 15/20; G10L 15/22; G10L 15/063

(57) ABSTRACT

A speech recognition system includes a collector for collecting speech data of a speaker, an articulation pattern classifier for extracting feature points of the speech data of the speaker and selecting an articulation pattern model corresponding to the feature points, a parameter tuner for tuning a parameter which is a reference for recognizing a speech command by using the selected articulation pattern model, and a speech recognition engine for recognizing the speech command of the speaker based on the tuned parameter.

### CROSS-REFERENCE TO RELATED APPLICATION

This application claims the benefit of priority to Korean Patent Application No. 10-2014-0158774, filed with the Korean Intellectual Property Office on Nov. 14, 2014, the entire contents of which are incorporated herein by reference.

### TECHNICAL FIELD

The present disclosure relates to a speech recognition system and a speech recognition method.

### BACKGROUND

A human-machine interface (HMI) interfaces a user with a machine through visual sensation, auditory sensation, or tactile sensation. Attempts have been made to use speech recognition as the HMI within a vehicle in order to minimize diversion of a driver's attention and to improve convenience.

According to a conventional speech recognition system, voices of various speakers using standard language are stored as speech data and speech recognition is performed using the speech data. However, in such a system, it is difficult to guarantee speech recognition performance since an articulation pattern (e.g., articulation intonation, articulation speed, and dialect) of a speaker using a speech recognition function is often different from the articulation pattern corresponding to the speech data.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide a speech recognition system and a speech recognition method having advantages of generating an articulation pattern model for each region based on speech data for each region, selecting the articulation pattern model corresponding to an extracted feature point, and tuning a parameter which is a reference for recognizing a speech recognition command.

A speech recognition system according to an exemplary embodiment of the present disclosure may include: a collector collecting speech data of a speaker; an articulation pattern classifier extracting feature points of the speech data of the speaker and selecting an articulation pattern model corresponding to the feature points; a parameter tuner tuning a parameter which is a reference for recognizing a speech command by using the selected articulation pattern model; and a speech recognition engine recognizing the speech command of the speaker based on the tuned parameter.

The speech recognition system may further include a preprocessor converting the analog speech data transmitted from the collector to digital speech data, correcting a gain of the speech data, and removing noise of the speech data.

The articulation pattern classifier may include: a speech database storing speech data for each region; a first feature point extractor extracting feature points of the speech data for each region stored in the speech database; a feature point database storing feature points of the speech data for each region extracted by the first feature point extractor; a feature point learner generating a learning model by learning a distribution a of the feature points of the speech data for each region stored in the feature point database, and generating an articulation pattern model for each region by using the learning model; and a model database storing the learning model and the articulation pattern model generated by the feature point learner.

The articulation pattern classifier may further include: a second feature point extractor extracting feature points of the speech data of the speaker received from the preprocessor; and an articulation pattern model selector selecting the articulation pattern model corresponding to the feature points extracted by the second feature point extractor.

The feature point learner may generate a distribution classifier for classifying distributions of feature points of speech data by using the learning model.

A speech recognition method according to an exemplary embodiment of the present disclosure may include: collecting speech data of a speaker; preprocessing the speech data; extracting feature points of the speech data; selecting an articulation pattern model corresponding to the extracted feature points; tuning a parameter which is a reference for recognizing a speech command by using the selected articulation pattern model; recognizing the speech command of the speaker based on the tuned parameter.

The preprocessing of the speech command may include: converting the analog speech data to digital speech data; and correcting a gain of the speech data; removing noise of the speech data.

The articulation pattern model may be generated by extracting feature points of speech data for each region stored in a speech database; storing the extracted feature points of the speech data for each region in a feature point database; generating a learning model by learning a distribution of feature points of speech data for each region stored in the feature point database; and generating an articulation pattern model for each region by using the learning model.

### BRIEF DESCRIPTION OF THE DRAWINGS

FIG. 1 is a block diagram of a speech recognition system according to an exemplary embodiment of the present disclosure.

FIG. 2 is a block diagram of an articulation pattern classifier according to an exemplary embodiment of the present disclosure.

FIG. 3 is a drawing for explaining a process of generating a learning model and an articulation pattern model for each region according to an exemplary embodiment of the present disclosure.

FIG. 4 is a drawing for explaining a driving mode of a speech recognition system according to an exemplary embodiment of the present disclosure.

FIG. 5 is a flowchart of a speech recognition method according to an exemplary embodiment of the present disclosure.

### DETAILED DESCRIPTION

Hereinafter, the present disclosure will be described more fully with reference to the accompanying drawings, in which exemplary embodiments of the disclosure are shown. As those skilled in the art would realize, the described embodiments may be modified in various different ways, all without departing from the spirit or scope of the present disclosure. The drawings and description are to be regarded as illustrative in nature and not restrictive, and like reference numerals designate like elements throughout the specification. Further, a detailed description of the widely known related art will be omitted.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

In the specification, “articulation pattern model” means a model that is used to express regional properties (e.g., articulation accent, articulation speed, and dialect) of speech data.

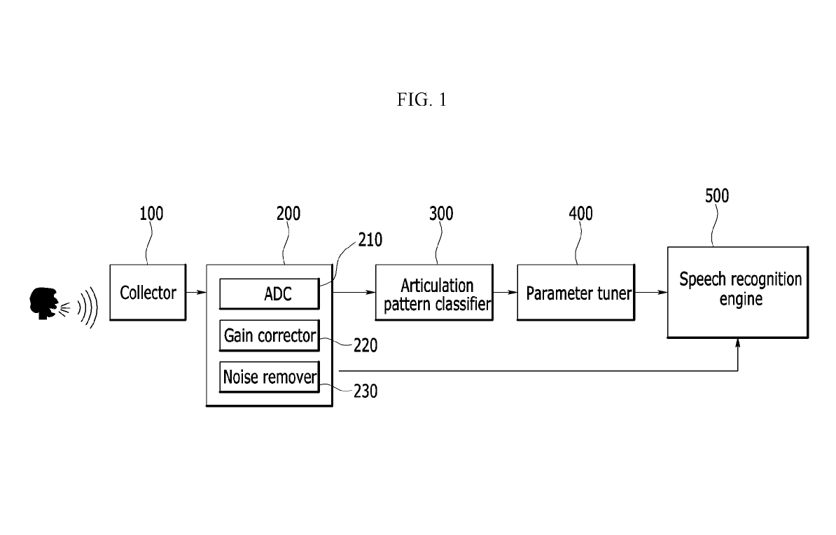

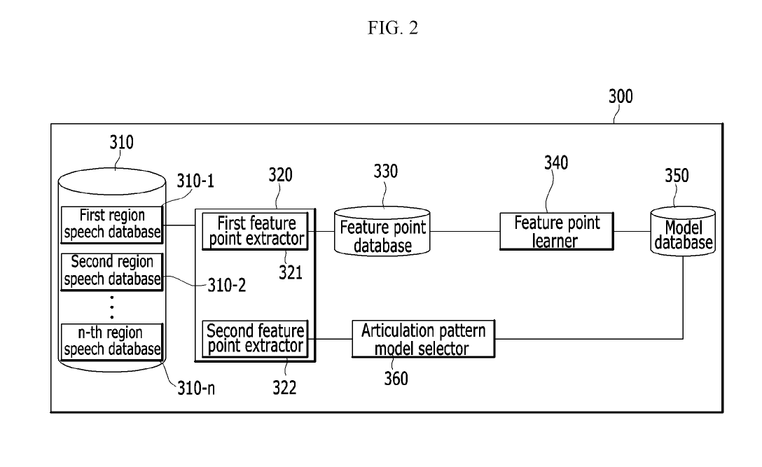

FIG. 1 is a block diagram of a speech recognition system according to an exemplary embodiment of the present disclosure, and FIG. 2 is a block diagram of an articulation pattern classifier according to an exemplary embodiment of the present disclosure.

As shown in FIG. 1, a speech recognition system according to an exemplary embodiment of the present disclosure may include a collector 100, a preprocessor 200, an articulation pattern classifier 300, a parameter tuner 400, and a speech recognition engine 500.

The collector 100 collects analog speech data of a speaker (user), and may include a microphone receiving a sound wave to generate an electrical signal according to vibrations of the sound wave.

The preprocessor 200 preprocesses the speech data and transmits the preprocessed speech data to the articulation pattern classifier and the speech recognition engine 500. The preprocessor 200 may include an analog to digital converter (ADC) 210, a gain corrector 220, and a noise remover 230.

The ADC 210 converts the analog speech data transmitted from the collector 100 to digital speech data (hereinafter referred to as “speech data”). The gain corrector 220 corrects a gain (level) of the speech data. The noise remover 230 removes noise from the speech data.

As shown in FIG. 2, the articulation pattern classifier 300 according to an exemplary embodiment of the present disclosure may include a speech database 310, a feature point extractor 320, a feature point database 330, a feature point learner 340, a model database 350, and an articulation pattern model selector 360.

The speech database 310 stores speech data for each region. For example, the speech database 310 may include a first region speech database 310-1, a second region speech database DB 310-2, and an n-th region speech database 310-n. The speech database 310 may be previously generated based on speech data of various speakers in an anechoic chamber. The speech database 310 may be updated based on speech data for each region transmitted from a remote server (e.g., telematics server).

In addition, the speech database 310 may be updated based on region information received from a user or speaker of the speech recognition system and the speech data transmitted from the preprocessor 200.

The feature point extractor 320 may include a first feature point extractor 321 and a second feature point extractor 322.

The first feature point extractor 321 extracts feature points of the speech data for each region stored in the speech database 310, and stores the feature points in the feature point database 330.

The second feature point extractor 322 extracts feature points of the speech data of the speaker received from the preprocessor 200, and transmits the feature points to the articulation pattern model selector 360.

The feature points for each region extracted by the first feature point extractor 321 are stored in the feature point database 330. For example, the feature point database 331 may include a first region feature point database, a second region feature point database, and an n-th region feature point database.

The feature point learner 340 may generate a learning model by learning the feature points of speech data for each region stored in the feature point database 330, and may generate an articulation pattern model for each region by using the learning model.

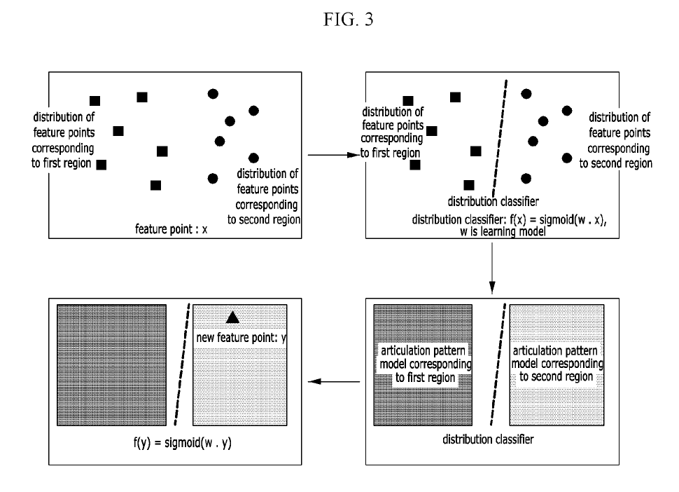

A process of generating the learning model and the articulation pattern model of the feature point learner 340 will be described with reference to FIG. 3.

FIG. 3 is a drawing for explaining a process of generating a learning model and an articulation pattern model for each region according to an exemplary embodiment of the present disclosure.

Referring to FIG. 3, the feature point learner 340 generates the learning model by learning a distribution of the feature points of the speech data for each region stored in the feature point database 330. A machine learning algorithm may be used to learn the distribution of the feature points of the speech data for each region. For example, the feature point learner 340 may learn a lo distribution of feature points of speech data corresponding to a first region stored in the first region feature point database and a distribution of feature points of speech data corresponding to a second region stored in the second region feature point database.

The feature point learner 340 may generate a distribution classifier for classifying distributions of feature points of speech data by using the learning model. The distribution classifier may be expressed in the following sigmoid function.)

ƒ(x)=sigmoid (w·x)

Herein, w is a learning model, and x is a feature point of speech data.

The feature point learner 340 may generate the articulation pattern model using the distribution classifier. For example, the feature point learner 340 may generate an articulation pattern model corresponding to the first region and an articulation pattern model corresponding to the second region by using a distribution classifier that classifies the distribution of feature points of speech data corresponding to the first region and the distribution of feature points of speech data corresponding to the second region.

The model database 350 stores the learning model and the articulation pattern model generated by the feature point learner 340.

The articulation pattern model selector 360 selects an articulation pattern model corresponding to the feature points extracted by the second feature point extractor 322 using the distribution classifier, and transmits the selected articulation pattern model to the parameter tuner 400. For example, as shown in FIG. 3, when a new feature point y is extracted by the second feature point extractor 322, the articulation pattern model selector 360 selects an articulation pattern model corresponding to the feature point y using the distribution classifier.

The parameter tuner 400 tunes a parameter which is a reference for recognizing a speech command by using the articulation pattern model selected by the articulation pattern model selector 360.

The speech recognition engine 500 recognizes a speech command of the speaker based on the parameter tuned by the parameter tuner 400. Speech-based devices may be controlled based on the speech command (i.e., speech recognition result). For example, a function (e.g., call function or route guidance function) corresponding to the recognized speech command may be executed.

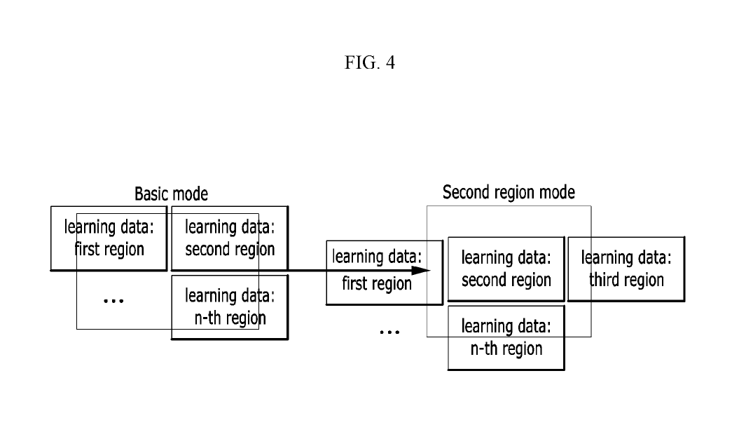

FIG. 4 is a drawing for explaining a driving mode of a speech recognition system according to an exemplary embodiment of the present disclosure.

Referring to FIG. 4, when the articulation pattern model corresponding to the second region is selected by the articulation pattern model selector 360, the parameter which is the reference for recognizing the speech command may be tuned to a value corresponding to the second region. In other words, a driving mode of the speech recognition engine 500 is changed from a basic mode (parameter=default value) to a second region mode (parameter=value corresponding to the second region).

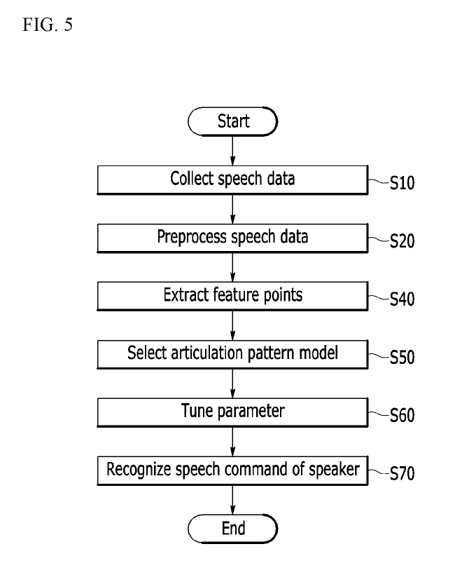

FIG. 5 is a flowchart of a speech recognition method according to an exemplary embodiment of the present disclosure. As shown in FIG. 5, the collector 100 collects speech data of the user at step S10. The speech data is transmitted to the preprocessor 200.

After that, the preprocessor 200 preprocesses the speech data at step S20. In detail, the preprocessor 200 converts the analog speech data transmitted from the collector 100 into digital speech data, corrects a gain of the speech data, and removes noise from the speech data. Accordingly, speech recognition performance of the speech data may be improved. The preprocessed speech data is transmitted to the second feature point extractor 322.

The second feature point extractor 322 extracts feature points of the speech data at step S30. The extracted feature points of the speech data is transmitted to the articulation pattern model selector 360.

The articulation pattern model selector 340 selects the articulation pattern model corresponding to the extracted feature point by using the distribution classifier at step S40. The selected articulation pattern model is transmitted to the parameter tuner 400.

The parameter tuner 400 tunes the parameter by using the selected articulation pattern model at step S50.

The speech recognition engine 500 recognizes the speech command of the speaker based on the tuned parameter at step S60.

As described above, according to an exemplary embodiment of the present disclosure, the parameter is tuned using the articulation pattern model corresponding to regional properties included in the speech data, thereby improving speech recognition performance.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A speech recognition system comprising:
a collector for collecting speech data of a speaker;
an articulation pattern classifier for extracting feature points of the speech data of the speaker and selecting an articulation pattern model corresponding to the feature points;
a parameter tuner for tuning a parameter which is a reference for recognizing a speech command by using the selected articulation pattern model; and
a speech recognition engine for recognizing the speech command of the speaker based on the tuned parameter.

2. The speech recognition system of claim 1, further comprising a preprocessor for converting the analog speech data transmitted from the collector to digital speech data, correcting a gain of the speech data, and removing noise from the speech data.

3. The speech recognition system of claim 2, wherein the articulation pattern classifier includes:
a speech database for storing speech data for each region;
a first feature point extractor for extracting feature points of the speech data for each region stored in the speech database;
a feature point database for storing feature points of the speech data for each region extracted by the first feature point extractor;
a feature point learner for generating a learning model by learning a distribution of the feature points of the speech data for each region stored in the feature point database, and for generating an articulation pattern model for each region by using the learning model; and
a model database for storing the learning model and the articulation pattern model generated by the feature point learner.

4. The speech recognition system of claim 3, wherein the articulation classifier further includes:
a second feature point extractor for extracting feature points of the speech data of the speaker received from the preprocessor; and
an articulation pattern model selector for selecting the articulation pattern model corresponding to the feature points extracted by the second feature point extractor.

5. The speech recognition system of claim 3, wherein the feature point learner generates a distribution classifier for classifying distributions of feature points of speech data by using the learning model.

6. A speech recognition method comprising:
collecting speech data of a speaker;
preprocessing the speech data;
extracting feature points of the speech data;
selecting an articulation pattern model corresponding to the extracted feature points;
tuning a parameter which is a reference for recognizing a speech command by using the selected articulation pattern model; and
recognizing the speech command of the speaker based on the tuned parameter.

7. The speech recognition method of claim 6, wherein the step of preprocessing the speech data includes:
converting the analog speech data into digital speech data;
correcting a gain of the speech data; and
removing noise from the speech data.

8. The speech recognition method of claim 6, wherein the articulation pattern model is generated by:
extracting feature points of speech data for each region stored in a speech database;
storing the extracted feature points of the speech data for each region in a feature point database;
generating a learning model by learning a distribution of feature points of speech data for each region stored in the feature point database; and
generating an articulation pattern model for each region by using the learning model.
